(19) United States
(12) Patent Application Publication
(10) Pub. No.: US 2016/0023282 A1
(43) Pub. Date: Jan. 28, 2016

(54) INDEXABLE INSERTS AND DRILLS COMPRISING THE SAME

(71) Applicant: Kennametal India Limited, Bangalore (IN)

(72) Inventor: Karthic RAMESH, Bangalore (IN)

(21) Appl. No.: 14/807,177

(22) Filed: Jul. 23, 2015

(30) Foreign Application Priority Data
Jul. 25, 2014 (IN) 3630CHE2014

(51) Int. Cl. B23B 51/04; B23B 27/16

(52) U.S. Cl. CPC B23B 51/048; B23B 27/1622; B23B 2200/081; B23B 2251/48

(57) ABSTRACT

In one aspect, cutting inserts are described herein comprising an indexable architecture including four cutting edges for material removal in cutting or drilling applications. A cutting insert described herein comprises four cutting edges formed by intersection of a rake face and flank faces, each cutting edge comprising a first linear portion connected to a second linear portion by a curved transition portion, wherein the second linear portion is parallel with an axis bisecting a virtual inscribed circle of the cutting insert and the first linear portion forming an angle θ with the axis.

### RELATED APPLICATION DATA

The present application claims priority pursuant to 35 U.S.C. §119(a) to Indian Patent Application Number 3630CHE2014 filed Jul. 25, 2014, which is hereby incorporated by reference in its entirety.

### FIELD

The present invention relates to cutting inserts and, in particular, to cutting inserts for use in drilling applications.

### BACKGROUND

Indexable cutting inserts and drills employing the same are generally known. Indexable cutting inserts permit efficiencies to be realized in large-scale cutting operations, particularly in high-wear cutting applications. Such inserts allow for rapid replacement upon substantial cutting edge wear. Further, various insert geometries enable use of a single drill or cutting apparatus across several different machining operations.

Cutting inserts and associated drills can further provide specialized cutting edges resulting in desirable characteristics of balanced cutting forces, wear resistance, uniformity of cut, material removal rate, chip control and surface finish of the workpiece. As demands of cutting and drilling applications continue to evolve, new cutting insert architectures and drill designs are required to overcome limitations of prior architectures and designs.

### SUMMARY

In one aspect, cutting inserts are described herein comprising an indexable architecture including four cutting edges for material removal in cutting or drilling applications. For example, a cutting insert described herein comprises four cutting edges formed by intersection of a rake face and flank faces, each cutting edge comprising a first linear portion connected to a second linear portion by a curved transition portion. The second linear portion of the cutting edge is parallel with an axis bisecting a virtual inscribed circle of the cutting insert and the first linear portion forming an angle θ with the axis. In some embodiments, θ ranges from 10° to 15°. Additionally, the curved transition portion can be convex at an intersection with the first linear portion and concave at an intersection with the second linear portion. The virtual inscribed circle can intersect each cutting edge at the curved transition portion. In some embodiments, each cutting edge is entirely formed by the first linear portion, the second linear portion and the curved transition portion. The cutting insert can also comprise an aperture for securing the insert to a tool body. In some embodiments, the aperture is centrally located in the rake face.

In another aspect, drills are described herein. A drill described herein comprises a drill body defining a longitudinal axis and having a first end and a second end, the first end being adapted for coupling a machine tool and the second end having at least one cutting insert pocket and a cutting insert disposed in the pocket. The cutting insert comprises four cutting edges formed by intersection of a rake face and flank faces, each cutting edge comprising a first linear portion connected to a second linear portion by a curved transition portion. The second linear portion of the cutting insert is parallel with an axis bisecting a virtual inscribed circle of the cutting insert, and the first linear portion forming an angle θ with the axis. In some embodiments, the insert pocket is disposed along the longitudinal axis of the drill body. Additionally, in some embodiments, the first linear portion of the insert cutting edge extends axially beyond the second end of the drill body. The drill can further comprise a second insert pocket and a second cutting insert disposed in the second pocket. The second cutting insert can have geometry different than the first cutting insert. In some embodiments, the cutting insert(s) are fastened to the insert pocket(s) by non-permanent mechanical joining

### BRIEF DESCRIPTION OF THE DRAWINGS

FIG. 1 illustrates a top plan view of a cutting insert according to one embodiment described herein.

FIG. 2 illustrates an elevational view of a cutting insert according to one embodiment described herein.

FIG. 3 illustrates a perspective view of a cutting insert according to one embodiment described herein.

FIG. 4 illustrates a perspective view of a drill according to one embodiment described herein.

### DETAILED DESCRIPTION

Embodiments described herein can be understood more readily by reference to the following detailed description and examples and their previous and following descriptions. Elements and apparatus described herein, however, are not limited to the specific embodiments presented in the detailed description. It should be recognized that these embodiments are merely illustrative of the principles of the present invention. Numerous modifications and adaptations will be readily apparent to those of skill in the art without departing from the spirit and scope of the invention.

### I. Four Cornered Cutting Inserts

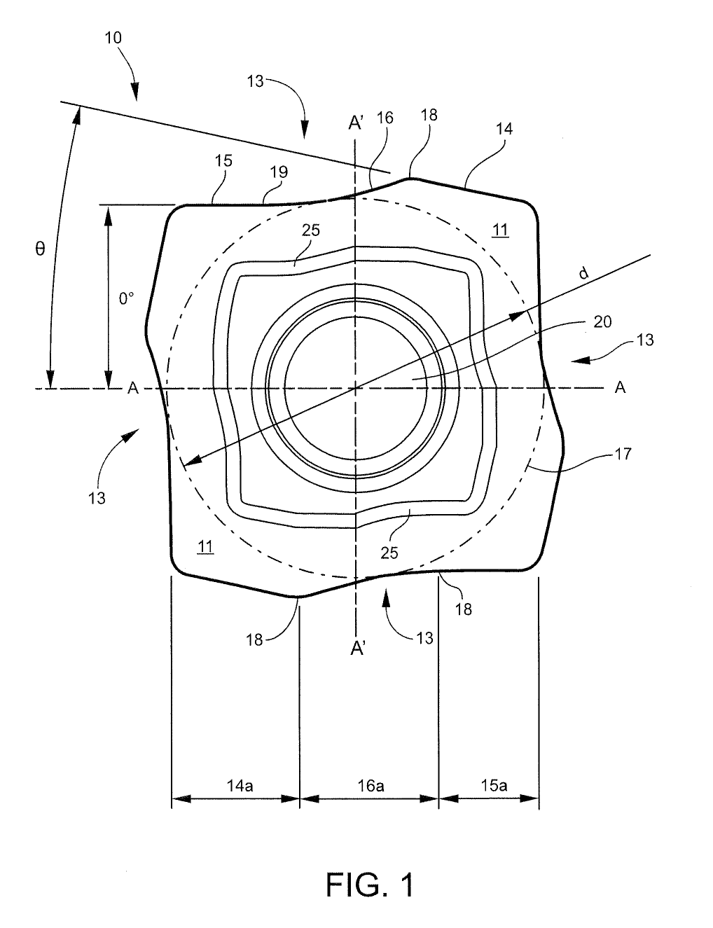

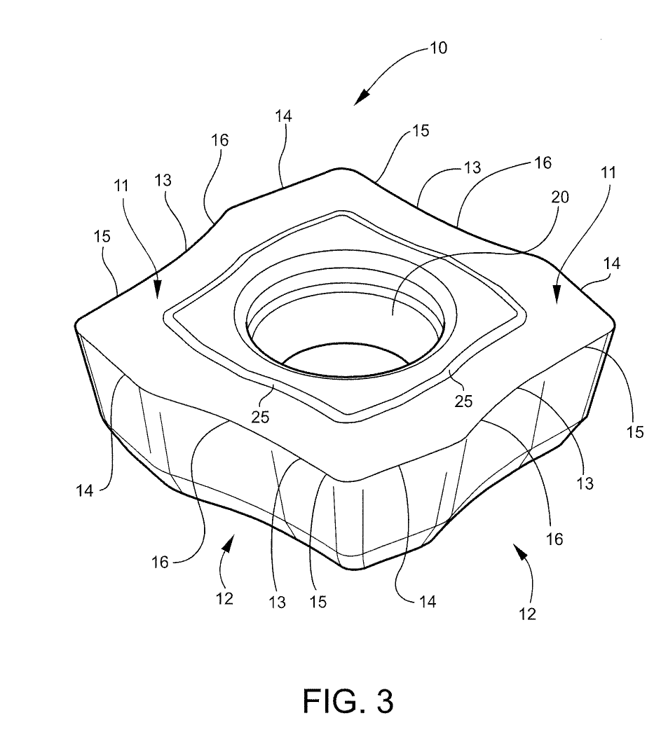

Referring now to FIGS. 1-3, there is illustrated a cutting insert, generally designated as reference number 10, in accordance with one embodiment described herein. As provided in FIGS. 1 and 3, the cutting insert (10) comprises four cutting edges (13) formed by intersection of a rake face (11) and flank faces (12). As illustrated by FIG. 1, each cutting edge (13) comprises a first linear portion (14) connected to a second linear portion (15) by a curved transition portion (16). The second linear portion (15) of each of two opposing cutting edges is parallel with an axis (A-A) bisecting a virtual inscribed circle (17) of the cutting insert (10), and the first linear portion (14) forming an angle θ with the axis (A-A). θ can have any value not inconsistent with the objectives of the present invention. For example, a value of θ can be selected from Table I.

TABLE I
Value of θ (degrees)

10-15
11-15
12-15
10-14
10-13
12-14

In contrast to the first linear portion (14), the second linear portion (15) is parallel or arranged at 0 degrees relative to the axis (A-A). The same angular analysis is repeated for the first and second linear portions (14, 15) of the remaining two cutting edges (13) of the insert (10) relative to axis (A′-A′), which also bisects the virtual inscribed circle (17) and is normal to axis (A-A).

Cutting edges (13) of the insert (10) can have any configuration or orientation not inconsistent with the objectives of the present invention. For example, the curved transition portion (16) can connect the first linear portion (14) to the second linear portion (15) in any desired manner. As illustrated the embodiment of FIG. 1, the curved transition portion (16) is convex at an intersection with the first linear portion (18) and concave or planar at an intersection with the second linear portion (19). Further, each cutting edge (13) can be entirely formed by the first linear portion (14), second linear portion (15) and curved transition portion (16).

The first and second linear portions (14, 15) and curved transition portion (16) can have any dimensions not inconsistent with the objectives of the present invention. In the embodiment of FIG. 1, for example, start and end points of the first linear portion (14), second linear portion (15) and the curved transition portion (16) are illustrated by the respective distances (14a, 15a, 16a) relative to the diameter (d) of the virtual inscribed circle (17). The first linear portion (14), for example, can extend along a cutting edge (13) a distance (14a) relative to the diameter (d) of the virtual inscribed circle (17). In some embodiments, the first linear portion (14) extends along a cutting edge (13) a distance (14a) of 0.3d to 0.4d. Similarly, the second linear portion (15) also extends along the cutting edge (13) a distance (15a) relative to the diameter (d) of the virtual inscribed circle (17) ranging from 0.25d to 0.3d. Additional cutting edge distances of the first and second linear portions (14, 15) relative to inscribed circle diameter can be independently selected from Table II.

TABLE II
Cutting Edge Distances of First and Second Linear Portions
Distance Relative to Inscribed Circle Diameter (d)

| First Linear Portion | Second Linear Portion |
|---|---|
| 0.3-0.39d | 0.26-0.3d |
| 0.3-0.38d | 0.25-0.29d |
| 0.3-0.37d | 0.25-0.28d |
| 0.32-0.36dP | 0.25-0.27d |
| 0.32-0.4d | 0.27-0.3d |

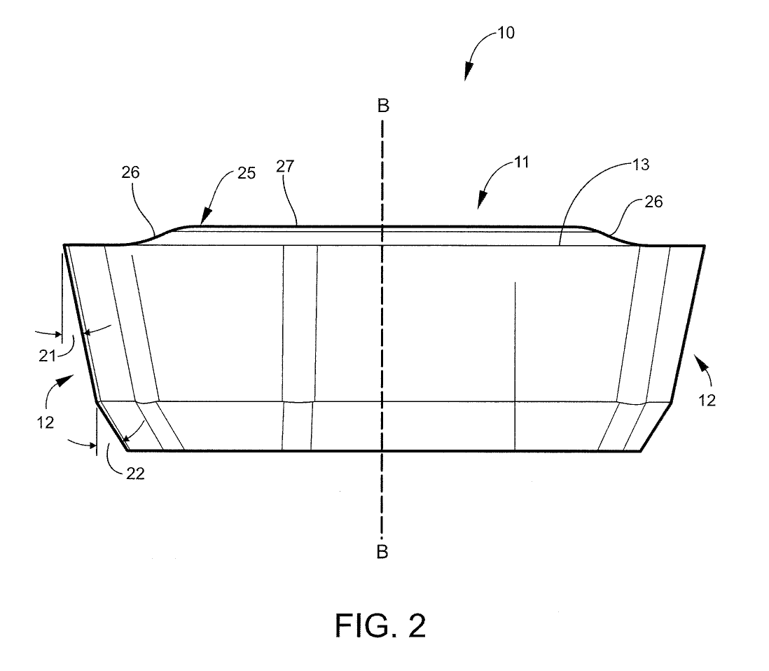

A cutting insert described herein can further comprise any additional elements, components, or configurations not inconsistent with the objectives of the present disclosure. For example, a cutting insert can comprise an aperture (20) for securing the cutting insert to a tool body. In some embodiments, the aperture (20) is centrally located in the rake face (11) and concentric to the virtual inscribed circle (17). A cutting insert described herein can also exhibit a rotational axis of symmetry (B-B). In some cases, a cutting insert demonstrates 180° rotational symmetry about rotational axis (B-B). Alternatively, a cutting insert can demonstrate 90° rotational symmetry about rotational axis (B-B). Further, cutting inserts described herein can comprise one or more chip breaker structures along the rake face (11). Any chip breaker structure not inconsistent with the objectives of the present invention can be employed. In some embodiments, a chip breaker structure can be a continuous ridge following the general contours of the cutting edges. As illustrated in FIGS. 1 and 3, the ridge of the chip breaker (25) generally mimics the perimeter shape of the cutting insert (10). Inclined surfaces (26) extend from the rake face (11) to the top surface (27) of the chip breaker (25) as provided in FIG. 2.

A cutting insert described herein can also exhibit at least one clearance angle along the flank faces as illustrated in FIG. 2. For example, flank faces (12) can exhibit at least a first clearance angle (21) proximate the rake face (11) and a second clearance angle (22) distal to the rake face (11). First and second clearance angles (21, 22) can subtend any angle not inconsistent with the objectives of the present invention. For example, the first clearance angle (21) can range from 10° to 15°, and the second clearance angle can range from 25° to 35°. Additional values for first and second clearance angles (21, 22) can be independently selected from Table III.

TABLE III
Clearance Angle Values (degrees)

| First Clearance Angle | Second Clearance Angle |
|---|---|
| 10-14 | 27-35 |
| 10-13 | 27-32 |
| 11-15 | 28-33 |
| 12-15 | 30-35 |
| 11-14 | 27-30 |

The first and/or second clearance angles (21, 22) can be disposed along any proportion of the flank faces. For example, the height of the first clearance formed by the first clearance angle (21) can be between 60 and 80% of the thickness of the cutting insert (10), between 65 and 80 percent of the thickness of the cutting insert (10) or between 70 and 80 percent of the thickness of the cutting insert (10).

Cutting inserts described herein can be formed of various materials including cemented carbide, cermet, ceramics, sintered cubic boron nitride, sintered diamond, silicon nitride or SiAlON. Cemented carbide, in some embodiments, comprises tungsten carbide (WC). WC can be present in a cutting insert in an amount of at least about 80 weight percent or in an amount of at least about 85 weight percent. Additionally, metallic binder of cemented carbide can comprise cobalt or cobalt alloy. Cobalt, for example, can be present in a cemented carbide insert in an amount ranging from 3 weight percent to 15 weight percent. In some embodiments, cobalt is present in an amount ranging from 5-12 weight percent or from 6-10 weight percent. Further, a cemented carbide insert may exhibit a zone of binder enrichment beginning at and extending inwardly from the surface of the substrate.

### II. Drills

In another aspect, drills are described herein. A drill described herein comprises a drill body defining a longitudinal axis and having a first end and a second end, the first end being adapted for coupling a machine tool and the second end having at least one insert pocket and a cutting insert disposed in the pocket. The cutting insert has four cutting edges formed by intersection of a rake face and flank faces, each cutting edge comprising a first linear portion connected to a second linear portion by a curved transition portion, wherein the second linear portion is parallel with an axis bisecting a virtual inscribed circle of the cutting insert and the first linear portion forming an angle θ with the axis.

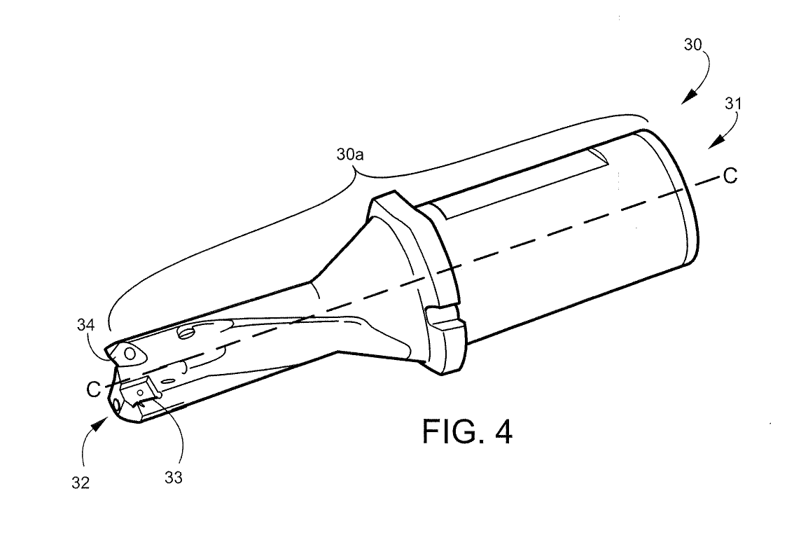

Referring now to FIG. 4, there is illustrated a drill, generally designated reference number (30), in accordance with one embodiment described herein. As illustrated in FIG. 4, the drill (30) comprises a first end (31) adapted for coupling a machine tool (not shown) and a second end (32) having at least one insert pocket (33) for receiving a cutting insert. In the embodiment of FIG. 4, the second end (32) has two insert pockets (33, 34). A first cutting insert having properties and design described in Section I hereinabove is disposed in at least one of the insert pockets (33, 34). For example, the cutting insert can comprise four cutting edges formed by intersection of a rake face and flank faces, each cutting edge comprising a first linear portion connected to a second linear portion by a curved transition portion. The second linear portion can be parallel with an axis bisecting a virtual inscribed circle of the cutting insert and the first linear portion can form an angle θ with the axis.

The cutting insert can be arranged or configured in any orientation not inconsistent with the objectives of the present invention. For example, the insert pocket can be disposed along the longitudinal axis (C-C). In such configurations, at least one cutting edge of the insert can be generally in line with the longitudinal axis (C-C). In some embodiments, the first linear portion of the insert cutting edge can extend axially beyond the second end of the drill body. Further, in some cases, the second linear portion of the insert cutting edge can be disposed collinear with an edge of the second end of the drill. In other embodiments, the second linear portion is positioned at an angle relative to the edge of the second end of the drill.

A second cutting insert can be secured in the remaining unoccupied insert pocket (33, 34). In some cases, the second cutting insert comprises geometry different than the first cutting insert. The first and second cutting inserts can be fastened, positioned or secured in the pockets by any means enabling facile and quick replacement of the cutting inserts once worn. For example, the cutting inserts can be secured in the pockets by screws or other mechanical fastening mechanisms.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A cutting insert comprising:
four cutting edges formed by intersection of a rake face and flank faces, each cutting edge comprising a first linear portion connected to a second linear portion by a curved transition portion, wherein the second linear portion is parallel with an axis bisecting a virtual inscribed circle of the cutting insert and the first linear portion forming an angle θ with the axis.

2. The cutting insert of claim 1, wherein the angle θ ranges from 10° to 15°.

3. The cutting insert of claim 1, wherein the curved transition portion is convex at an intersection with the first linear portion and concave at an intersection with the second linear portion.

4. The cutting insert of claim 1, wherein the virtual inscribed circle intersects each cutting edge at the curved transition portion.

5. The cutting insert of claim 1, wherein each cutting edge is entirely formed by the first linear portion, second linear portion and curved transition portion.

6. The cutting insert of claim 1 further comprising an aperture for securing the cutting insert to a tool body.

7. The cutting insert of claim 6, wherein the aperture is centrally located in the rake face.

8. The cutting insert of claim 1, wherein the first linear portion extends along the cutting edge a distance of 0.3d to 0.4d, wherein d is the diameter of the virtual inscribed circle.

9. The cutting insert of claim 8, wherein the second linear portion extends along the cutting edge a distance of 0.25d to 0.3d.

10. The cutting insert of claim 1, wherein the flank faces exhibit at least one clearance angle.

11. The cutting insert of claim 10, wherein the flank faces have first clearance angle proximate the rake face and a second clearance angle distal to the rake face.

12. The cutting insert of claim 10, wherein first clearance angle ranges from 10° to 15°.

13. The cutting insert of claim 10, wherein second clearance angle ranges from 25° to 35°.

14. The cutting insert of claim 1, wherein the rake face comprises one or more chip breaker structures.

15. The cutting insert of claim 1 having a rotational axis of symmetry.

16. A drill comprising:
a drill body defining a longitudinal axis and having a first end and a second end, the first end being adapted for coupling a machine tool and the second end having at least one insert pocket adapted to receive a cutting insert; and
at least one cutting insert disposed in the at least one insert pocket, the cutting insert comprising:
four cutting edges formed by intersection of a rake face and flank faces, each cutting edge comprising a first linear portion connected to a second linear portion by a curved transition portion, wherein the second linear portion is parallel with an axis bisecting a virtual inscribed circle of the cutting insert and the first linear portion forming an angle θ with the axis.

17. The drill of claim 16, wherein at least one insert pocket is disposed along the longitudinal axis.

18. The drill of claim 16, wherein the first linear portion of at least one cutting edge extends axially beyond the second end of the drill body.

19. The drill of claim 16 further comprising at least a second insert pocket adapted to receive a cutting insert and second cutting insert disposed in the second insert pocket.

20. The drill of claim 19, wherein the second cutting insert comprises a geometry different than the first cutting insert.

21. The insert of claim 16, wherein the at least one insert is fastened to the insert pocket by non-permanent mechanical joining.

22. The insert of claim 21, wherein the at least one insert is fastened to the insert pocket by a screw.
